(19) United States
(12) Patent Application Publication
(10) Pub. No.: US 2016/0195990 A1
(43) Pub. Date: Jul. 7, 2016

(54) ELECTRONIC DEVICE AND TOUCH SCAN METHOD THEREOF

(71) Applicant: Samsung Electronics Co., Ltd., Suwon-si (KR)

(72) Inventors: Dong Kyoon Han, Seongnam-si (KR); Soo Hyung Kim, Hwaseong-si (KR); Jong Kon Bae, Seoul (KR); Yong Man Lee, Seongnam-si (KR); Louis Hyunsuk Jung, Hwaseong-si (KR)

(21) Appl. No.: 14/990,049

(22) Filed: Jan. 7, 2016

(30) Foreign Application Priority Data
Jan. 7, 2015 (KR) 10-2015-0002117

(51) Int. Cl. G06F 3/041; G06F 3/16; G06F 3/0354; G06F 3/0346; G06F 3/047; G06F 3/0488

(52) U.S. Cl. CPC G06F 3/0416; G06F 3/047; G06F 3/04883; G06F 3/03545; G06F 3/0412; G06F 3/0346; G06F 3/167; G06F 2203/04106

(57) ABSTRACT

An electronic device is provided. The electronic device includes a touch panel including a plurality of transmission electrode lines and a plurality of receiving electrode lines and a touch panel operation module configured to select a part of the plurality of transmission electrode lines and the plurality of receiving electrode lines and to sense a partial area of the touch panel based on a sensing mode.

### CROSS-REFERENCE TO RELATED APPLICATION(S)

This application claims the benefit under 35 U.S.C. §119(a) of a Korean patent application filed on Jan. 7, 2015 in the Korean Intellectual Property Office and assigned Serial number 10-2015-0002117, the entire disclosure of which is hereby incorporated by reference.

### TECHNICAL FIELD

The present disclosure relates to an electronic device including a touch sensor and a touch sensing method thereof.

### BACKGROUND

With the development of electronic technologies, various types of electronic devices have been developed and supplied. Furthermore, human life is becoming more convenient and prosperous with the development of electronic technologies. In particular, portable electronic devices, such as a smart phone, a notebook personal computer (PC), a tablet PC, a wearable device, and the like, have been increasingly used.

A touch sensor has been applied as an input device to most portable electronic devices being recently developed. The touch sensor may support an intuitive user manipulation in the small electronic devices, such as a smart phone, a tablet PC, and the like.

Even though the touch manipulation is inputted on a partial area of the screen of the electronic device which includes the touch sensor, the entire area may be continuously sensed, which is disadvantageous in terms of power consumption and the sensing speed. This fact is recognized as a serious problem in a portable electronic device using a limited power source.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device which is capable of reducing power consumption by changing the sensing area or the sensing mode of the touch sensor and a touch sensing method thereof.

Another aspect of the present disclosure is to provide an electronic device which is capable of recognizing a touch manipulation more accurately and faster by improving the sensitivity of a sensing area and by simultaneously sensing specific areas on which the sensing is required and a touch sensing method thereof.

In accordance with an aspect of the present disclosure, an electronic device is provided. The electronic device includes a touch panel including a plurality of transmission electrode lines and a plurality of receiving electrode lines and a touch panel operation module configured to select a part of the plurality of transmission electrode lines and the plurality of receiving electrode lines and to sense a partial area of the touch panel based on a sensing mode.

In accordance with another aspect of the present disclosure, a touch sensing method of an electronic device is provided. The touch sensing method includes setting a sensing mode and a sensing area of a touch panel including a plurality of transmission electrode lines and a plurality of receiving electrode lines, selecting a transmission electrode line and a receiving electrode line corresponding to the set sensing area, and sensing a partial area of the touch panel based on the set sensing mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to various embodiments of the present disclosure;

FIG. 2 is a diagram schematically illustrating a touch panel and a touch panel operation module according to various embodiments of the present disclosure;

FIG. 3 is a diagram schematically illustrating a transmission channel selection switch according to various embodiments of the present disclosure;

FIG. 4 is a diagram schematically illustrating a receiving channel selection switch according to various embodiments of the present disclosure;

FIG. 5 is a diagram schematically illustrating a configuration of a touch panel and a touch panel operation module according to various embodiments of the present disclosure;

FIG. 6 is a diagram schematically illustrating a configuration of a touch panel and a touch panel operation module according to various embodiments of the present disclosure;

FIG. 7 is a diagram schematically illustrating a configuration of a touch panel and a touch panel operation module according to various embodiments of the present disclosure;

FIGS. 8A and 8B are diagrams illustrating setting of a sensing area according to various embodiments of the present disclosure;

FIGS. 9A and 9B are diagrams illustrating setting of the maximum number of touches according to various embodiments of the present disclosure;

FIGS. 10A and 10B are diagrams illustrating setting of a sensing area based on an input of a touch manipulation according to various embodiments of the present disclosure;

FIGS. 11A and 11B are diagrams illustrating setting of a sensing area based on an input of a touch manipulation according to various embodiments of the present disclosure;

FIGS. 12A and 12B are diagrams illustrating a change of a sensing area according to a location of a touch manipulation according to various embodiments of the present disclosure; and

FIG. 13 is a flowchart illustrating a touch sensing method of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In the present disclosure, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group phase 1 or phase 2 (MPEG-1 or MPEG-2) audio layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™ Apple TV™, or Google TV™), game consoles (e.g., Xbox™ and PlayStation™) electronic dictionaries, electronic keys, camcorders, electronic picture frames, and the like.

According to various embodiments of the present disclosure, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices) receiving a user input in an idle mode, navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. According to various embodiments of the present disclosure, an electronic device may be a flexible electronic device. Also, electronic devices according to various embodiments of the present disclosure are not limited to the above-mentioned devices, and may include new electronic devices according to technology development.

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

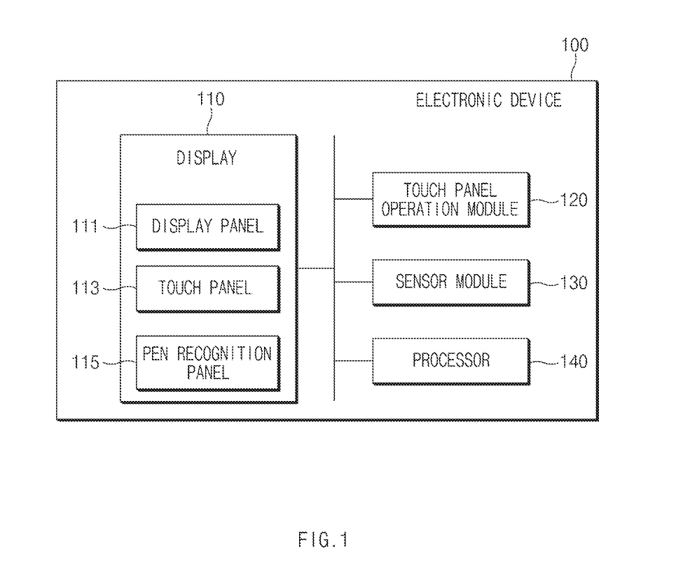

FIG. 1 is a block diagram illustrating a configuration of an electronic device according to various embodiments of the present disclosure.

Referring to FIG. 1, an electronic device 100 may include a display 110, a touch panel operation module 120, a sensor module 130, and a processor 140. According to various embodiments of the present disclosure, at least one of the above-mentioned components of the electronic device 100 may be omitted, or the electronic device 100 may further include other components.

According to an embodiment of the present disclosure, the display 110 may include a display panel 111, a touch panel 113, or a pen recognition panel 115.

According to an embodiment of the present disclosure, the display panel 111 may be a panel on which an image, a text, or the like is displayed. For example, the display panel 111 may be a liquid crystal display (LCD) panel, an organic light emitting diode (OLED) panel, or the like on which an image, a text, or the like is displayed. According to an embodiment of the present disclosure, the display panel 111 may display user interfaces (UIs) of various applications executed by the processor 140.

According to an embodiment of the present disclosure, the touch panel 113 may be located above or below the display panel 111. According to an embodiment of the present disclosure, the touch panel 113 may include electrodes arranged in the form of lattice on an entire area or a partial area of the display panel 111 and the display panel 111 may be transparent to be visible from the outside. According to various embodiments of the present disclosure, the touch panel 113 may include lattices which correspond to pixels of the display panel 111 or each of which is larger or smaller in size than the pixel.

The touch panel 113 may include a plurality of transmission and receiving channels which are simultaneously drivable. According to various embodiments of the present disclosure, a specific channel of the touch panel 113 may be selected based on a UI, an operating state of a running application or a sensor module, or the like. According to an embodiment of the present disclosure, the touch panel 113 may be driven or sensed, for a group, based on the selected transmission and receiving channel.

A driving signal generated from the touch panel operation module 120 may be provided to the touch panel 113. A change in a capacitance or an electric field formed according to the corresponding driving signal may occur if a specific object is adjacent to a specific location of the touch panel 113 while the driving signal is transferred. The change in the electric field may be provided to the touch panel operation module 120 as a received signal of the touch panel 113.

The pen recognition panel 115 may be a panel which senses a pen input. According to an embodiment of the present disclosure, the pen recognition panel 115 may operate in a manner the same as or different from the touch panel 113. For example, the pen recognition panel 115 may operate in a capacitive mode like the touch panel 113 or in an electromagnetic resonance (EMR) mode (or an electromagnetic induction mode). In the case where the pen recognition panel 115 operates in the capacitive mode, the touch panel 113 and the pen recognition panel 115 may be the same panel.

The touch panel operation module 120 may generate a driving signal for simultaneous multi-channel driving or multi-channel sensing of the touch panel 113 and may provide the driving signal to the touch panel 113. For example, the touch panel operation module 120 may generate the driving signal in which orthogonal codes are distributed and assigned to sub-carriers configured with a plurality of frequencies being orthogonal each other. For example, the above-mentioned driving signal may be generated by multi-carrier code division multiplexing signal generation. A unique orthogonal code assigned to each channel of the touch panel 113 may be, for example, a Hardamard code, a gold code, a Kasami code, a pseudo noise (PN) code, or the like. The driving signal may be generated by performing the inverse discrete cosine transform (IDCT) of the unique orthogonal codes assigned to each channel. To reduce a peak to average power ratio (PAPR) of the signal generated by IDCT, the touch panel operation module 120 may use clipping or peak reducing transmission signal composition. The generated driving signal may be repeatedly re-used as a unique signal assigned to each channel without iterative calculation. In this regard, information related to the generated driving signal may be stored in a memory.

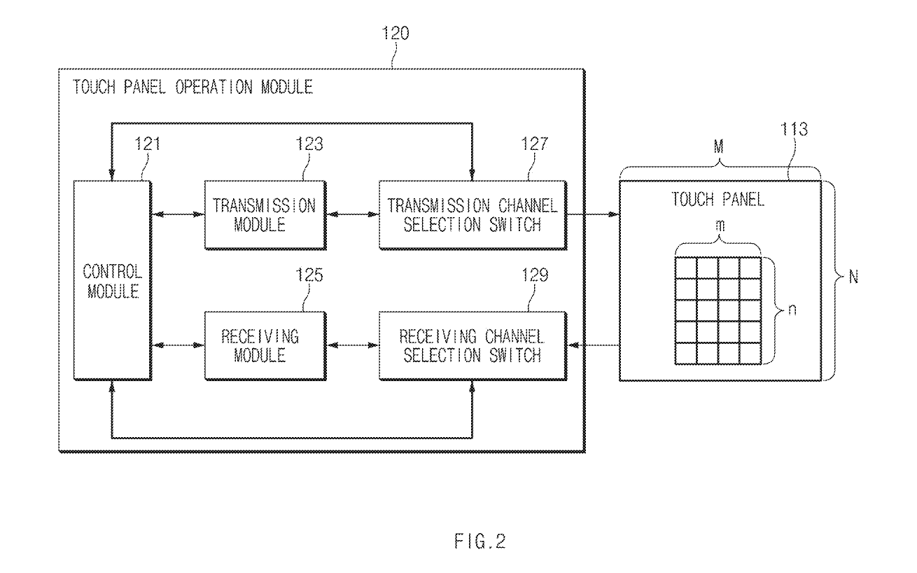

FIG. 2 is a diagram schematically illustrating a touch panel and a touch panel operation module according to various embodiments of the present disclosure.

Referring to FIG. 2, a plurality of electrodes (e.g., transparent electrodes) may be arranged on the touch panel 113 in the form of a lattice (or a matrix). For example, M columns (e.g., a transmission channel or a plurality of transmission electrode lines) and N rows (e.g., a receiving channel or a plurality of receiving electrode lines) may be arranged on the touch panel 113 so as to intersect with each other. According to an embodiment of the present disclosure, the touch panel 113 may be driven for a channel of m (<=M) columns and n (<=N) rows. Alternatively, the touch panel 113 may drive m-by-n electrode lines among M-by-N electrode lines under control of the touch panel operation module 120.

Referring to FIG. 2, the touch panel operation module 120 may include a control module 121, a transmission module 123, a receiving module 125, a transmission channel selection switch 127, or a receiving channel selection switch 129.

According to an embodiment of the present disclosure, the control module 121 may control the supply of driving signals (or transmission signals or transmission channel signals) of the transmission module 123 and may analyze received signals (or sensor signals or receiving channel signals) which the receiving module 125 receives.

According to various embodiments of the present disclosure, the control module 121 may set a sensing mode or a sensing area of the touch panel 113 based on a UI, an operating state of a running application or the sensor module, or the like. For example, under control of the control module 121, the sensing mode may be set to an event detection mode, a living body sensing mode, a one-touch mode, a two-touch mode, or the like. According to an embodiment of the present disclosure, in the case where the sensing mode or the sensing area is set, the control module 121 may select at least a part of a plurality of transmission and receiving electrode lines (or channels) of the touch panel 113 and may sense a specific area of the touch panel 113 based on the set sensing mode. For example, the control module 121 may control the transmission channel selection switch 127 such that driving signals are supplied into the specific area of the touch panel 113 through at least a part selected from a plurality of transmission channels of the touch panel 113. Furthermore, the control module 121 may control the receiving channel selection switch 129 such that received signals are received from the specific area of the touch panel 113 through at least a part selected from a plurality of receiving channels of the touch panel 113.

According to an embodiment of the present disclosure, the control module 121 may analyze the received signals which the receiving module 125 receives from the touch panel 113. The control module 121 may determine whether a touch manipulation is inputted on the touch panel 113 or whether a touch manipulation is inputted at a specific location or a specific area of the touch panel 113, based on the analysis result.

The transmission module 123 may generate the driving signals under control of the control module 121. According to an embodiment of the present disclosure, the transmission module 123 may generate the driving signals based on the set sensing mode. According to an embodiment of the present disclosure, the transmission module 123 may generate driving signals corresponding to code information or signal information provided from the control module 121. Accordingly, a driving signal generated by the transmission module 123 may include a unique code. According to an embodiment of the present disclosure, the transmission module 123 may generate a plurality of driving signals corresponding to a plurality of code information or signal information. The transmission module 123 may provide the generated driving signals to the touch panel 113. According to an embodiment of the present disclosure, the transmission module 123 may transfer the driving signals to different areas of the touch panel. For example, the transmission module 123 may simultaneously transfer the driving signals thus generated to the specific electrode lines (or channels) of the touch panel 113 selected by the transmission channel selection switch 127. According to an embodiment of the present disclosure, the transmission module 123 may simultaneously provide different driving signals into the transmission channels of the touch panel 113.

According to an embodiment of the present disclosure, the transmission module 123 may generate an analog signal and may transfer the analog signal into the touch panel 113. According to an embodiment of the present disclosure, the transmission module 123 may provide the analog signal, which includes unique code information, to the touch panel 113 over a carrier of a specific frequency band.

The receiving module 125 may detect a received signal(s) provided from at least a partial area (e.g., the set receiving channel(s)) of the touch panel 113. According to an embodiment of the present disclosure, the receiving module 125 may detect the received signal provided from an electrode line (or a channel), selected by the receiving channel selection switch 129, from among a plurality of electrode lines (or channels) of the touch panel 113. For example, if a partial area of the touch panel 113 is selected by the receiving channel selection switch 129, the receiving module 125 may detect the received signal provided from the selected partial area. According to an embodiment of the present disclosure, the receiving module 125 may detect received signals, for a partial area of the touch panel 113 (e.g., for specific receiving electrodes). The receiving module 125 may convert signals, which are obtained by amplifying and filtering the detected received signals, to digital signals and may provide the digital signals to the control module 121.

According to an embodiment of the present disclosure, the receiving module 125 may simultaneously process driving signals by differentiating signals, for a transmission channel, using a unique code included in the received signal. For example, in the case where the touch panel 113 includes M transmission channels and N receiving channels, the transmission module 123 and the receiving module 125 may simultaneously sense (or scan) m-by-n nodes in a simultaneous multi-channel driving and multi-channel sensing manner, thereby improving the sensing speed.

The transmission channel selection switch 127 may be connected to a plurality of transmission channels (or transmission electrode lines) of the touch panel 113. The transmission channel selection switch 127 may include a plurality of switches for selecting at least a part of a plurality of transmission channels of the touch panel 113. For example, the transmission channel selection switch 127 may include at least one switch which selects at least a part of a plurality of transmission channels of the touch panel 113, for example, for a group.

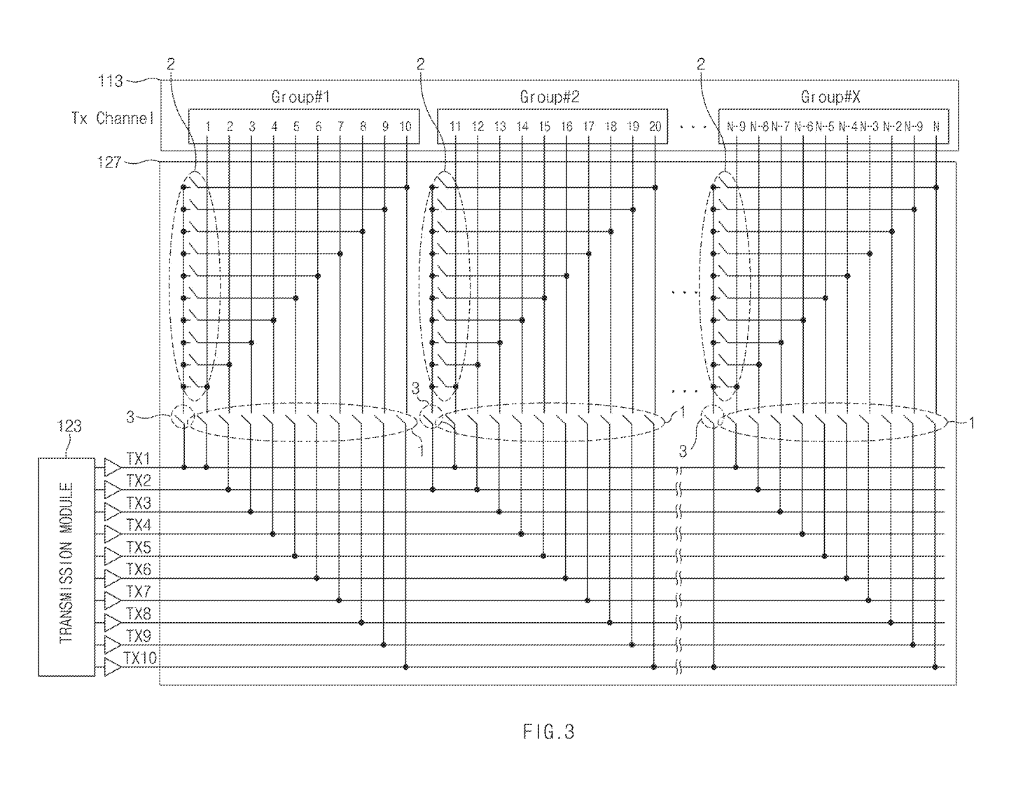

FIG. 3 is a diagram schematically illustrating a transmission channel selection switch according to various embodiments of the present disclosure.

Referring to FIG. 3, the touch panel 113 may include a plurality of transmission channels (e.g., N transmission channels), and the transmission channels may be connected to the transmission module 123 through the transmission channel selection switch 127. According to an embodiment of the present disclosure, the transmission channel selection switch 127 may include individual selection switches 1 and 2 and group selection switches 3. Each of the individual selection switches 1 and 2 may be connected to one of the transmission channels of the touch panel 113 such that the transmission channels are individually selected. The individual selection switches may include the individual selection switch 1 which operates in a normal mode and the individual selection switch 2 which operates in a low-power mode. In the normal mode, each of the individual selection switches 1 may be connected to one of transmission drivers of the transmission module 123. According to an embodiment of the present disclosure, a plurality of transmission channels included in a specific group of the touch panel 113 may be sequentially connected to a plurality of transmission drivers of the transmission module 123 through the individual selection switch 1 operating in the normal mode. For example, 10 transmission channels included in a group #1 of the touch panel 113 may be sequentially connected to 10 transmission drivers of the transmission module 123, respectively. The individual selection switch 2 operating in the low-power mode may be connected to a transmission driver to which the group selection switch 3 is connected, through the group selection switch 3. At least a part of a plurality of transmission channels of the touch panel 113 may be selected for a group (or for an area). According to an embodiment of the present disclosure, the group selection switch 3 may select transmission channels, which correspond to the number of channels capable of being operated by one transmission driver, for a group. Each of the group selection switches 3 may be connected to one of the transmission drivers. Accordingly, it may be possible to sense a specific area using a part of the transmission drivers. The number of transmission drivers when the group selection switch 3 and the individual selection switch 2 operating in the low-power mode are used may be smaller than the number of transmission drivers when only the individual selection switch 1 operating in the normal mode is used, thereby reducing power consumption. For example, in the case where the group #1 of the touch panel 113 is selected, driving signals may be provided using one transmission driver TX1 in the low-power mode and driving signals may be provided using all transmission drivers TX1 to TX10 in the normal mode. The control module 121 may select a specific channel to which a driving signal is to be provided, by controlling a plurality of switches included in the transmission channel selection switch 127, respectively.

The receiving channel selection switch 129 may be connected to a plurality of receiving channels (or receiving electrode lines) of the touch panel 113. The receiving channel selection switch 129 may include a plurality of switches for selecting at least a part of the receiving channels of the touch panel 113. For example, the receiving channel selection switch 129 may include at least one switch which selects at least a part of the receiving channels of the touch panel 113 for a group.

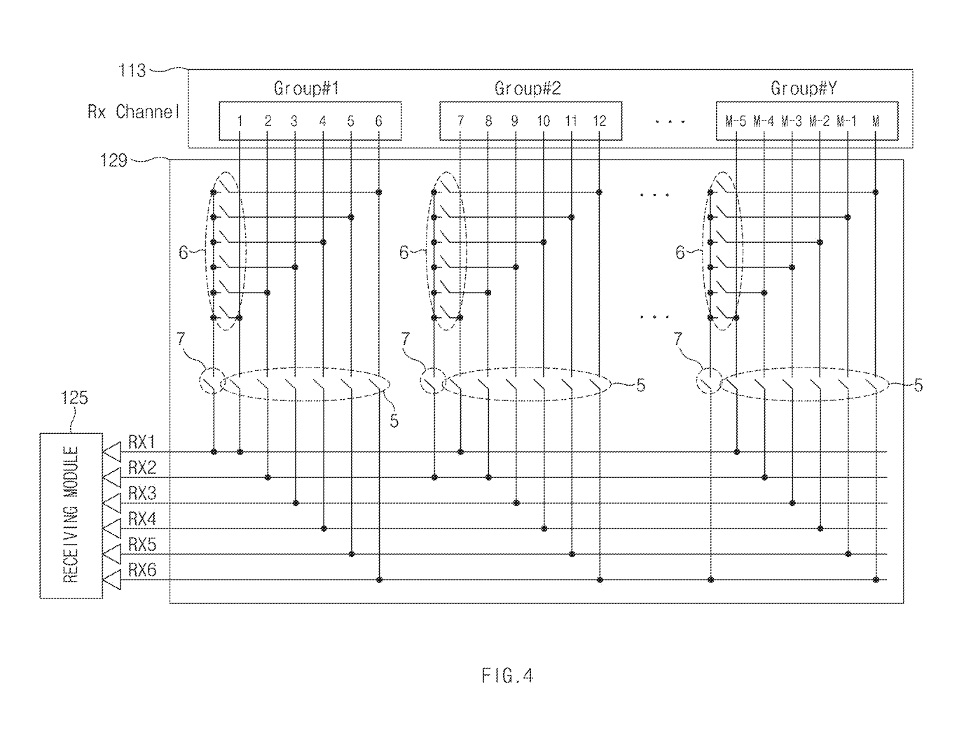

FIG. 4 is a diagram schematically illustrating a receiving channel selection switch according to various embodiments of the present disclosure.

Referring to FIG. 4, the touch panel 113 may include a plurality of receiving channels (e.g., M channels), and the receiving channels may be connected to the receiving module 125 through the receiving channel selection switch 129. According to an embodiment of the present disclosure, the receiving channel selection switch 129 may include individual selection switches 5 and 6 and group selection switches 7. The individual selection switches 5 and 6 may be connected to one of the plurality of receiving channels so as to be individually selected. The individual selection switches may include the individual selection switch 5 which operates in a normal mode and the individual selection switch 6 which operates in a low-power mode. According to an embodiment of the present disclosure, a plurality of receiving channels included in a specific group of the touch panel 113 may be sequentially connected to a plurality of receiving drivers of the receiving module 125 through the individual selection switch 5 operating in the normal mode. For example, 6 receiving channels included in a group #1 of the touch panel 113 may be sequentially connected to 6 transmission drivers of the receiving module 125. The individual selection switch 6 which operates in the low-power mode may be connected to a receiving driver, which is connected to the group selection switch 7, through the group selection switch 7. The receiving channel selection switch 129 may select a part of a plurality of receiving channels of the touch panel 113 for a group (or for an area). According to an embodiment of the present disclosure, the group selection switch 7 may select receiving channels, which correspond to the number of channels capable of being operated by one receiving driver, for a group. Each of the group selection switches 7 may be connected to one of the receiving drivers. Accordingly, it may be possible to sense a specific area using a part of the receiving drivers. The number of receiving drivers when the group selection switch 7 and the individual selection switch 6 operating in the low-power mode are used may be smaller than the number of receiving drivers when only the individual selection switch 5 operating in the normal mode is used, thereby reducing power consumption. For example, in the case of using the group #1 of the touch panel 113, signals may be received using one receiving driver RX1 in the low-power mode and signals may be received using all receiving drivers RX1 to RX6 in the normal mode. The control module 121 may respectively control a plurality of switches included in the receiving channel selection switch 129 and may select a specific channel through which the received signal is provided to the receiving module 125.

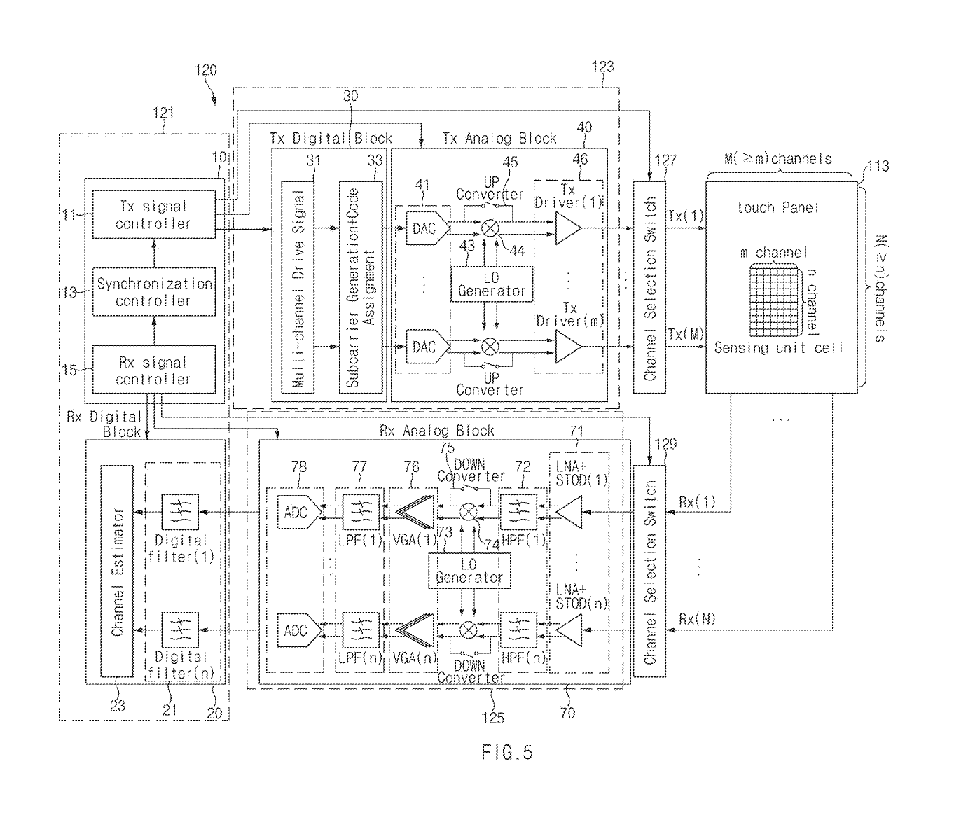

FIG. 5 is a diagram schematically illustrating a configuration of a touch panel and a touch panel operation module according to various embodiments of the present disclosure.

Referring to FIG. 5, the touch panel operation module 120 according to various embodiments of the present disclosure may include a control module 121, a transmission module 123, a receiving module 125, a transmission channel selection switch 127, or a receiving channel selection switch 129.

In the touch panel 113, M electrode lines may be arranged in a first direction, and N electrode lines may be arranged in a second direction crossing with the first direction. The M electrode lines may be used as driving signal supply lines and the N electrode lines may be used as received signal acquisition lines. The above-mentioned touch panel 113 may operate by the channel selection switches 127 and 129, for electrode lines (e.g., m-by-n electrode lines).

The transmission module 123 may include, for example, a transmission digital block 30 and a transmission analog block 40.

The transmission digital block 30 may include, for example, a signal generator 31 which generates a multi-channel driving signal (e.g., a module to obtain an orthogonal frequency division multiplexing (OFDM) signal) and a code assigner 33 (e.g., a module to obtain and assign a code division multiple access (CDMA) signal). The signal generator 31 may generate a signal according to OFDM scheme. The signal generator 31 may provide the generated signal to the code assigner 33. For example, the code assigner 33 may deliver the code-assigned signal to the transmission analog block 40 over a plurality of orthogonal sub-carrier frequencies. According to various embodiments of the present disclosure, the transmission digital block 30 may generate a waveform of a digital-to-analog converter (DAC) 41 by calling a signal sequence prepared for multi-channel driving.

The transmission analog block 40 may include a DAC 41, a first carrier generator 43, a first mixer 44, a first bypass switch 45, and a transmission driver 46. The DAC 41 may convert digital signals from the code assigner 33 to analog signals. The output signals of the DAC 41 may be provided to a first mixer 44 based on a setting. The first carrier generator 43 may generate and provide a specific frequency signal (e.g., more than 500 KHz) to the first mixer 44. The specific frequency signal may have a specific frequency band. The output signals of the DAC 41 may be provided to the transmission drivers 46 through the first mixers 44 over the specific frequency band. The above-mentioned first mixer 44 may perform a role of an up-converter.

The transmission driver 46 may amplify the output of the first mixer 44 and may provide the amplified output to the transmission channel selection switch 127. The first bypass switch 45 may provide a path through which the output signals of the DAC 41 are directly provided to the transmission driver 46. The touch panel operation module 120 may directly provide the driving signals to the transmission driver 46 according to the setting without mixing the driving signal with the carrier. In this regard, the touch panel operation module 120 may control to operate or not to operate (e.g., control for signals to be bypassed) the first mixer 44 by changing the state of the first bypass switch 45.

The transmission channel selection switch 127 may provide the driving signals from the transmission drivers 46 to at least one of a plurality of electrode lines of the first electrode layer arranged on the touch panel 113. At this time, the transmission channel selection switch 127 may provide the driving signals to a plurality of electrode lines respectively or may provide the driving signals to a specific group (e.g., the specific number of electrode lines) according to a setting. For example, if ten driving signals are provided from the transmission analog block 40, the transmission channel selection switch 127 may provide the ten driving signals to a plurality of electrode lines, respectively. Alternatively, the transmission channel selection switch 127 may divide a plurality of electrode lines into ten groups and may provide different driving signals for a group.

The receiving module 125 may include a receiving analog block 70.

The receiving channel selection switch 129 may be connected to the second electrode layer of the touch panel 113. The receiving channel selection switch 129 may be selectively switched to receive either the received signal of each of a plurality of electrode lines of the second electrode layer or the received signals of a part of a plurality of electrode lines. Alternatively, the receiving channel selection switch 129 may scan a plurality of electrode lines of the second electrode layer for a group and may provide the received signals, received for a group, to the receiving analog block 70.

The receiving analog block 70 may include an amplifier 71, a high-pass filter 72, a second mixer 74, a second bypass switch 75, a second carrier generator 73, a variable gain amplifier (VGA) 76, a low-pass filter 77, and an analog-to-digital converter (ADC) 78.

The amplifier 71 may amplify the received signals provided through the receiving channel selection switch 129. For example, the amplifier 71 may be low noise amplifiers (LNAs). The signals amplified by the amplifier 71 may be provided to the high-pass filter 72. According to various embodiments of the present disclosure, the amplifier 71 may perform, for example, a role of single to differential output (STDO).

The high-pass filter 72 may filter out signals, which have frequencies lower than a specific frequency band, from among the received signals amplified by the amplifier 71. For example, in the transmission module 123, a signal may be converted into a driving signal with which a carrier of several MHz is modulated through the first mixer 44, and the driving signal may be provided to the receiving module 125 with various kinds of noises of which frequencies are lower than several hundred KHz, while passing through the panel. The high-pass filter 72 may filter out energy provided from the touch panel 113, for example, a signal of several hundred KHz, without affecting the baseband signal.

The received signal passing through the high-pass filter 72 may be recovered to the baseband signal in the second mixer 74 of the receiving module 125. In this regard, the second mixer 74 may cancel the carrier generated by the first carrier generator 43 by multiplying the carrier generated by the second carrier generator 73 with the received signal.

The second bypass switch 75 may provide a direct path through which the signal passing through the high-pass filter 72 is transmitted to the VGA 76 without going through the second mixer 74. In the case where the frequency multiplication with the specific carrier through the first mixer 44 is not performed in the transmission module 123, for example, in the case where the driving signal is delivered to the transmission driver 46 through the first bypass switch 45, the second bypass switch 75 may become active. In the case where the signal is provided using the specific frequency in the transmission module 123, for example, in the case where the frequency multiplication with the specific frequency through the first mixer 44 is performed, the second bypass switch 75 may become inactive.

The VGA 76 may perform the variable gain amplification. The VGA 76 may perform the variable gain amplification several times such that signals passing through the second mixer 74 have the specific gain. The signals amplified by the VGA 76 may be provided to the low-pass filter 77. The low-pass filter 77 may remove the energy of the specific frequency band from the signals and may provide the signals, from which the energy of the specific frequency band is removed, to the ADC 78. The ADC 78 may convert transmitted analog signals to digital signals and may provide the digital signals to the control module 121.

The control module 121 may include, for example, a signal controller 10 and a signal evaluator 20.

The signal evaluator 20 may be a component of the receiving module 125. The signal evaluator 20 may include a digital filter 21 and a channel estimator 23. Signals provided from the receiving module 125 may include a background white noise. Accordingly, the digital filter 21, such as a moving average filter and the like, may be used to remove the background white noise or to further remove a noise not removed during the analog to digital conversion, thereby making the shape of the signal clearer.

The channel estimator 23 may evaluate whether the touch means is adjacent to any channel, by detecting signals converted using a specific algorithm, for example, least squares (LS) channel estimation algorithm, and performing the channel evaluation based on the detection result. The evaluation result of the channel estimator 23 may be provided to the processor 140 so as to be applied to the currently operating function or to act as an input event about execution of a new function. Alternatively, the evaluation result may be invalidated according to the operating function.

The signal controller 10 may include a driving signal controller 11, a synchronization controller 13, and a received signal controller 15.

The driving signal controller 11 may control the transmission digital block 30, the transmission analog block 40, and the transmission channel selection switch 127 such that driving signals are provided to the touch panel 113. For example, the driving signal controller 11 may control the switch state of the transmission channel selection switch 127 such that signals are provided to at least a part of the electrode lines of the touch panel 113. Furthermore, the driving signal controller 11 may control the transmission digital block 30 so as to generate an orthogonal frequency and a signal to which a code is assigned or so as to obtain a code sequence stored in the memory. The driving signal controller 11 may control whether to operate the first mixer 44 of the transmission analog block 40 and may control the multiplication with the specific frequency based on the operation of the first mixer 44.

The synchronization controller 13 may control the signal synchronization of the driving signal controller 11 and the received signal controller 15. For example, the synchronization controller 13 may control the synchronization between the signal generation in the first carrier generator 43 and the signal generation in the second carrier generator 73. In the case where the first carrier generator 43 and the second carrier generator 73 are united to operate as one carrier generator, it may be possible to control the baseband signal of the driving signal and an operation of the carrier generator. Furthermore, the synchronization controller 13 may perform the synchronization of the signal supply of the driving signal controller 11 and a signal evaluation of the signal evaluator 20. The delay time may occur between the first carrier generator 43 and the second carrier generator 73 and between the driving signal controller 11 and the signal evaluator 20, due to the characteristics of the circuit path of the touch panel 113 and the like. The synchronization controller 13 may synchronize the phases of both signals in the light of the delay time.

The received signal controller 15 may control the receiving module 125 or the signal evaluator 20. For example, the received signal controller 15 may adjust the number of receiving channels to be verified at the same time by controlling the switching state of the receiving channel selection switch 129 based on the setting. The received signal controller 15 may control the operation of the second mixer 74 by controlling the receiving analog block 70. For example, the received signal controller 15 may control the operation of the second mixer 74 in the same manner corresponding to the operation of the first mixer 44 of the driving signal controller 11.

As described above, the touch panel operation module 120 according to various embodiments of the present disclosure may assign at least one or more driving signals, which are generated based on the orthogonal frequency and the code assigned signal in the transmission module 123, for a channel, may provide the at least one more driving signals thus assigned to the touch panel 113, and may restore the received signal. Accordingly, a signal may have the orthogonal characteristic, signals may be simultaneously supplied to a plurality of channels using the code assigned driving signal, and the received signals may be differentiated with reliability. Furthermore, the touch panel operation module 120 according to various embodiments of the present disclosure may supply, for example, driving signals to the touch panel 113 over the specific frequency, thereby making it possible to drive the touch panel 113 in the frequency band in which the noise does not occur.

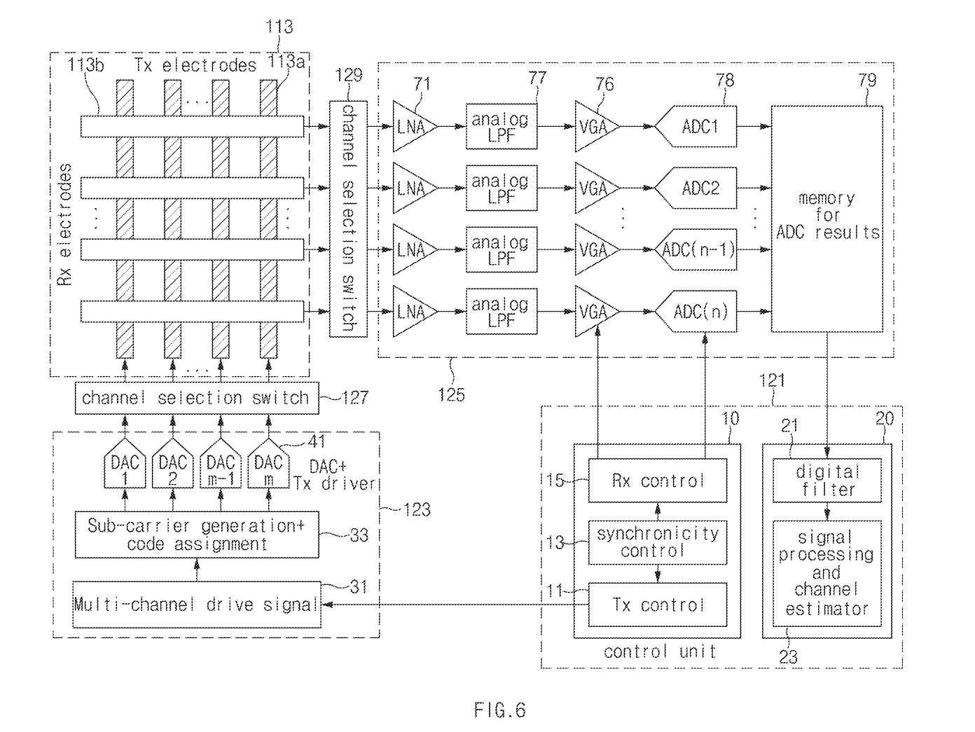

FIG. 6 is a diagram schematically illustrating a configuration of a touch panel and a touch panel operation module according to various embodiments of the present disclosure.

Referring to FIG. 6, the touch panel operation module 120 according to various embodiments of the present disclosure may include the control module 121, the transmission module 123, the receiving module 125, the transmission channel selection switch 127, and the receiving channel selection switch 129.

The touch panel 113 may have a structure which is the same as or similar to the touch panel 113 illustrated in FIG. 5. According to an embodiment of the present disclosure, the touch panel 113 may include a first electrode layer 113a and a second electrode layer 113b. According to an embodiment of the present disclosure, the first electrode layer 113a may include a plurality of transmission electrodes (or channels) which are spaced apart from each other by a specific distance in a first direction (or a vertical direction). According to an embodiment of the present disclosure, the second electrode layer 113b may include a plurality of receiving electrodes (or channels) spaced apart from each other by a specific distance in a second direction (or a horizontal direction) which intersects the first direction.

The first electrode layer 113a may be connected to the transmission module 123 through the transmission channel selection switch 127. The plurality of electrode lines included in the first electrode layer 113a may generate an electric field of which the magnitude corresponds to driving signals provided from the transmission module 123. The plurality of electrode lines (e.g., transmission channels) included in the first electrode layer 113a may be arranged in an area (e.g., the front, the side, the back, or the like of the display panel of the electronic device 100) where a user touch is possible.

The second electrode layer 113b may be connected to the receiving module 125 through the receiving channel selection switch 129. Signals may be applied to a plurality of electrode lines included in the second electrode layer 113b through the electric field, and the signals may be provided to the receiving module 125 as the received signals. The plurality of electrode lines (e.g., receiving channels) included in the second electrode layer 113b may be arranged in an area (e.g., the front, the side, the back, or the like of the display panel of the electronic device 100) where a user touch is possible.

The transmission module 123 may include, for example, a signal generator 31 which generates the multi-channel driving signal, a code assigner 33 which generates the sub-carrier or assigns the code, or a DAC 41 and transmission driver 46. The code assigner 33 may provide the transmission signals, configured with the sum of a plurality of sub-carriers in which a code is assigned to an orthogonal frequency, to DACs 41. The number of the sub-carriers may be determined to correspond to an operation of a plurality of channels (e.g., driving the transmission electrode lines arranged on the touch panel 113 with a plurality of driving signals). The DAC 41 and transmission driver 46 may convert digital signals provided from the code assigner 33 to analog signals, may amplify the analog signals to have the specific magnitude, and may deliver the amplified signals to the transmission channel selection switch 127. The transmission channel selection switch 127 may provide driving signals to at least a partial area of the touch panel 113 (e.g., m transmission electrodes), according to the setting.

The receiving channel selection switch 129 may control the switching state such that the receiving module 125 simultaneously sense the received signals by unit group comprises at least one receiving electrode (e.g., n receiving electrodes).

The receiving module 125 may include the amplifier 71, the low-pass filter 77, the VGA 76, the ADC 78, and the received signal buffer 79. The amplifier 71 may amplify a weak signal, and the VGA 76 may perform the variable gain amplification. The ADC 78 may convert the variable gain amplified signal to a digital signal and may provide the converted digital signal to the received signal buffer 79. The received signal buffer 79 may temporarily store signals provided from the ADC 78 and may provide the signals into the control module 121.

The control module 121 may include the signal controller 10 and the signal evaluator 20. The signal controller 10 may include the driving signal controller 11, the synchronization controller 13, and the received signal controller 15. The driving signal controller 11 may control the transmission module 123 with regard to the generation of the multi-channel driving signal. The received signal controller 15 may control the magnitude of the variable gain amplification and the ADC 78.

The signal evaluator 20 may include the digital filter 21 and the channel estimator 23. With regard to the improvement of the recognition rate of the signal, the digital filter 21 may perform the additional signal processing for waveform restoring based on a plurality of digital filters as described above. The channel estimator 23 may evaluate a location on which the touch occurs, by using the specific channel estimation algorithm.

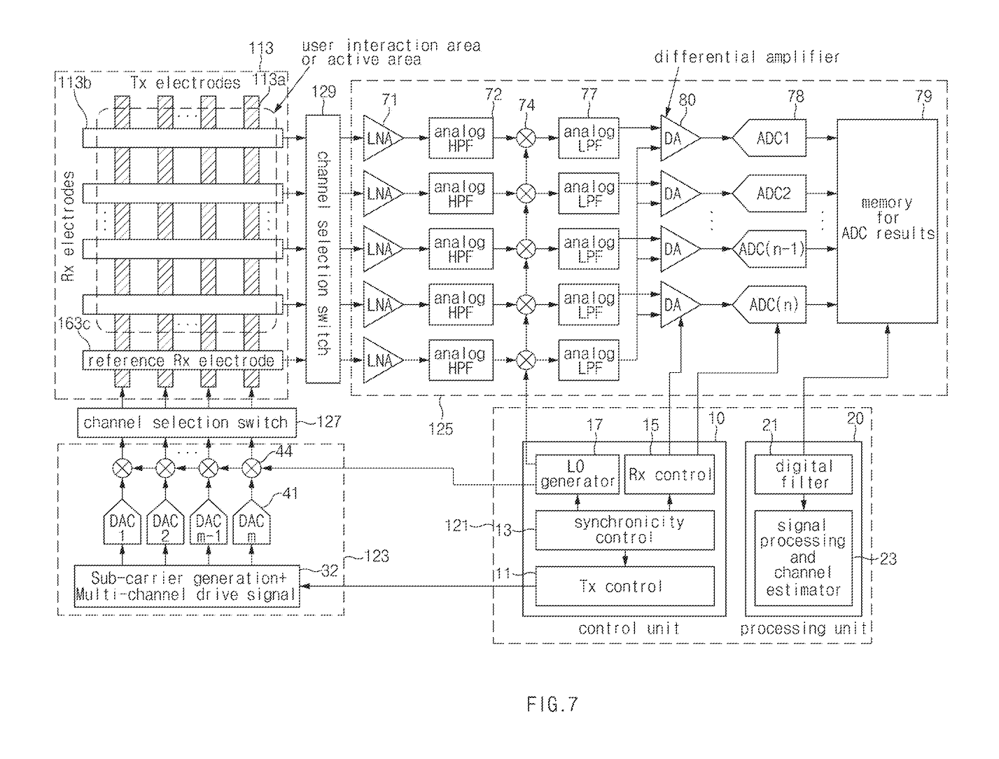

FIG. 7 is a diagram schematically illustrating a configuration of a touch panel and a touch panel operation module according to various embodiments of the present disclosure.

Referring to FIG. 7, the touch panel operation module 120 according to various embodiments of the present disclosure may include the control module 121, the transmission module 123, the receiving module 125, the transmission channel selection switch 127, and the receiving channel selection switch 129.

The touch panel 113 may have a structure in which a reference electrode 163c is added to the touch panel 113 illustrated in FIG. 6. For example, the touch panel 113 may include the first electrode layer 113a which includes a plurality of transmission electrodes spaced apart from each other by a specific distance in the first direction and the second electrode layer 113b which includes a plurality of receiving electrodes spaced apart from each other by a specific distance in the second direction which is different from the first direction. The second electrode layer 113b of the touch panel 113 may additionally or alternatively include the reference electrode 163c. The output signal of the reference electrode 163c may be delivered to the receiving module 125. The reference electrode 163c may be located in an area on which a user touch does not occur. For example, the reference electrode 163c may be disposed in the electronic device 100, for example, an enclosure (e.g., a case and the like).

The transmission module 123 may include, for example, a signal generator 32 which generates the multi-channel driving signal and the sub-carrier, a DAC 41 which converts digital signals to analog signals and additionally and alternatively amplifies the driving signals, and the first mixer 44 which mixes the carrier provided from the control module 121 with the driving signals. The first mixers 44 may include a path through which the carrier is provided in sequence. For example, if the carrier of the specific frequency band is provided to the mill first mixer 44, the mill first mixer 44 may deliver the corresponding carrier to the m−1^{th} first mixer 44. Accordingly, the carrier may be provided to all the first mixers 44 in sequence. Even though the carrier is sequentially provided to the first mixers 44 through the path, synchronization may be made in fact from the viewpoint of signal processing. To this end, the signal generator 32 may provide a unique code sequence in the order from the m^{th} DAC 41 to the first DAC 41.

The receiving module 125 may include the amplifier 71, the high-pass filter 72, the second mixer 74, the low-pass filter 77, the differential amplifier 80, the ADC 78, and the received signal buffer 79. At least one of the receiving channel selection switch 129, the amplifier 71, the high-pass filter 72, the low-pass filter 77, or the ADC 78 may perform a role which is the same as or similar to components described in FIGS. 5 and 6. For example, the high-pass filter 72 or the low-pass filter 77 may remove the specific frequency band which includes the noise component, to remove the additional noise component distributed in the frequency band other than the frequency band provided from the transmission module 123. The second mixer 74 may multiply the signal passing through the high-pass filter 72 with the carrier provided from the carrier generator 17 placed in the control module 121. The carrier provided to the second mixer 74 may be the same as the carrier provided to the first mixer 44 under control of the synchronization controller 13. The second mixer 74 may be placed to receive and process the output signal of the respective high-pass filter 72 and may deliver the carrier to a second mixer adjacent thereto.

The differential amplifier 80 may amplify a differential voltage between the signal provided through the reference electrode 163c and the signal passing through the low-pass filter 77. In this regard, the receiving module 125 may include a path which includes the first amplification module, the high-pass filter, the second mixer, and the low-pass filter related to the reference electrode 163c. A voltage formed at the reference electrode 163 may be provided to each of the differential amplifiers 80 as a reference voltage. The touch panel operation module 120 may attenuate the common noise component from the touch panel 113 and the circuit path, by operating the reference electrode 163c and the differential amplifier 80. The reference electrode 163c may be placed in the enclosure (e.g., the case and the like) of the electronic device 100. To remove only a common noise component from a differential amplifier with a change of a transmission signal maintained, a signal which is an inverted version of a signal received from any other receiving channel may be prepared so as to be used as a transmission signal only for the reference electrode.

The control module 121 may include the signal controller 10 and the signal evaluator 20. The signal controller 10 may include the driving signal controller 11, the received signal controller 15, and the synchronization controller 13. The driving signal controller 11 may control the signal generator 32 of the transmission module 123. The received signal controller 15 may control, for example, the operation of the differential amplifier 80 and the ADC 78. The synchronization controller 13 may control the synchronization processing for the driving signal controller 11 and the received signal controller 15 and may control the carrier supply synchronization of the carrier generator 17.

The signal evaluator 20 may include the digital filter 21 and the channel estimator 23. The signal evaluator 20 may detect a location, which is changed according to the touch input, using a specific channel estimation algorithm like the signal evaluator 20 illustrated in FIG. 5. According to an embodiment of the present disclosure, the signal evaluator 20 may estimate a channel based on the match filtering.

Referring to FIG. 1, the sensor module 130 may convert the measured or detected information to an electric signal by measuring a physical quantity or detecting an operating state of the electronic device 100. The sensor module 130 may include, for example, a gesture sensor, a gyro sensor, a pressure sensor, an acceleration sensor, an infrared sensor, a microphone, and the like. According to an embodiment of the present disclosure, the sensor module 130 may include a sensor hub to control the sensors included therein. The sensor hub may provide data obtained from the sensors included in the sensor module 130 to the touch panel operation module 120 or the processor 140.

The processor 140 may control an overall operation of the electronic device 100. For example, the processor 140 may control the hardware or software components connected to the processor 140 by driving an operating system or an application program and may perform various data processing and arithmetic operations.

According to an embodiment of the present disclosure, the processor 140 may provide information related to the running application to the touch panel operation module 120. For example, the processor 140 may determine the effective touch area of a UI displayed on the display panel 111 in response to the execution of the application and may provide information about the effective touch area (or information about a remaining area other than the effective touch area) to the touch panel operation module 120. The effective touch area may mean an area on which the user manipulation is inputted or required. For another example, the processor 140 may provide information about the maximum number of touches corresponding to the UI displayed on the display panel 111 based on the execution of the application, to the touch panel operation module 120. For still another example, the processor 140 may provide information about the sensing mode of the touch panel corresponding to the running application, to the touch panel operation module 120. According to an embodiment of the present disclosure, the processor 140 may determine the effective touch area, the maximum number of touches, or the sensing mode about the UI displayed on the display panel 111, using metadata included in the running application. The metadata may include information about the area on which the specific UI is displayed, the number of touches required for the specific UI, the sensing mode required for the specific UI, and the like.

According to various embodiments of the present disclosure, the touch panel operation module 120 may set the sensing mode or the sensing area based on the information provided from the display 110, the sensor module 130, the processor 140, and the like. The touch panel operation module 120 may select at least a part of a plurality of transmission and receiving electrode lines of the touch panel 113 and may control to sense a specific area of the touch panel 113 based on the set sensing mode, based on the UI, the operating state of the running application or the sensor module, or the like.

According to an embodiment of the present disclosure, if information about the effective touch area of the UI displayed on the display panel 111 is received from the processor 140, the touch panel operation module 120 may control to sense the partial area corresponding to the effective touch area. The effective touch area may mean an area on which the user manipulation is inputted or required.

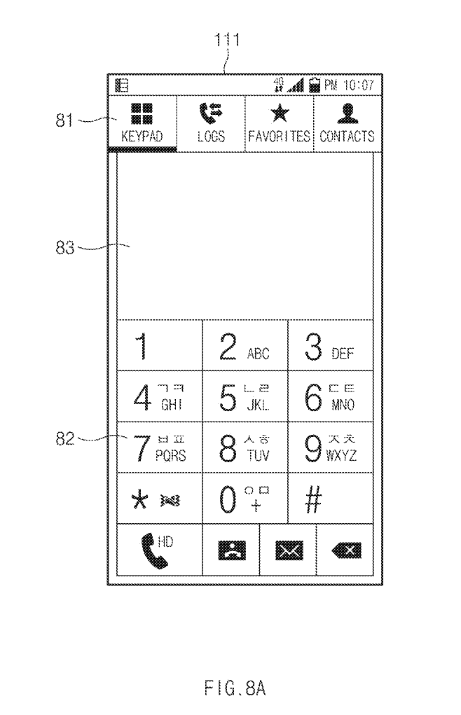

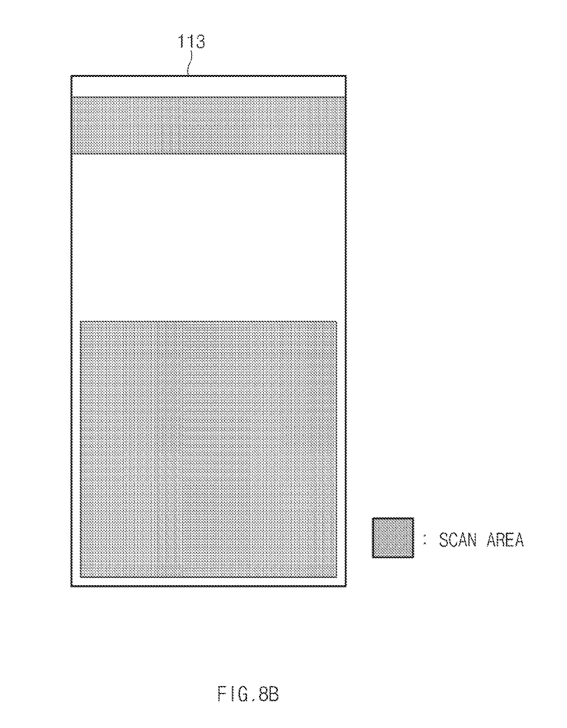

FIGS. 8A and 8B are diagrams illustrating setting of a sensing area according to various embodiments of the present disclosure.

FIG. 8A shows a call application UI displayed on the display panel 111. The processor 140 may control or analyze the UI displayed on the display panel 111. For example, the processor 140 may perform control to display the specific UI in the specific area of the display panel 111. Furthermore, the processor 140 may determine and provide the effective touch area of the UI displayed on the display panel 111 to the touch panel operation module 120.

Referring to FIG. 8A, the call application UI may include a menu icon 81, a key pad 82, and an empty area 83 included in the call application. For example, areas of the menu icon 81 and the key pad 82 of the UIs displayed on the display panel 111 may be areas on which the user manipulation is inputted, and the empty area 83 may be an area on which the user manipulation is not required. Accordingly, the processor 140 may determine the area of the menu icon 81 or the key pad 82 as the effective touch area. While generating the screen to be displayed on the display panel 111, the processor 140 may deliver information associated with an area which has a UI related to the touch input and with an area which is not related to the touch input, to the touch panel operation module 120. The touch panel operation module 120 may set different sensor driving modes with respect to the effective touch area which includes UI related to the touch input and an area which is not the effective touch area. The sensor driving mode which the touch panel operation module 120 selects may be a mode in which coordinates are extracted by driving and sensing all the channels of the touch panel 113, a mode in which the presence or absence of the touch or approach is detected although a plurality of channels of the touch panel 113 is not driven and sensed for a group to extract coordinates, a mode which the driving and sensing for an area corresponding to a group of a plurality of channels of the touch panel 113 is discontinued, a mode which the driving and sensing speed of the sensor varies in the mode in which the coordinates are extracted or the presence or absence of the touch or approach is only sensed, or a mode which the number of objects touched in the mode in which coordinates of the touch input are extracted is changed into one, two, ten, or the like.

Referring to FIG. 8B, the touch panel operation module 120 may set an area corresponding to the effective touch area of the display panel 111 as the sensing area of the touch panel 113.

According to an embodiment of the present disclosure, if a partial area of the touch panel 113 is set as the sensing area, the touch panel operation module 120 may set the sensing rate of the sensing area to be higher than that when the entire area is sensed. According to an embodiment of the present disclosure, if a partial area of the touch panel 113 is set as the sensing area, the touch panel operation module 120 may set the signal throughput of the sensing area to be higher than that when the entire area is sensed. For example, the touch panel operation module 120 may perform additional signal processing, such as filtering, with respect to the sensing area. According to an embodiment of the present disclosure, the touch panel operation module 120 may differently set the sensing rate and the signal throughput about a partial area of the touch panel 113, based on whether a sensing mode set for a partial area of the touch panel 113 is a mode in which whether the user touches is only sensed or a mode in which touch coordinates are sensed. For example, in the case where a partial area of the touch panel 113 is set to sense the touch coordinates, the touch panel operation module 120 may set the sensing rate and the signal throughput to be higher than that at the sensing mode in which whether the user touch is only sensed.

According to an embodiment of the present disclosure, the touch panel operation module (e.g., the touch panel operation module 120) may sense touch inputs corresponding to the number of touches, if the information about the maximum number of touches for the UI displayed on the display panel 111 is received. For example, the touch panel operation module 120 may set the maximum number of touches to be inputted in the specific area of the touch panel 113, if the information about the number of touches related to the UI displayed on the display panel 111 is received from the processor (e.g., the processor 140). The touch panel operation module 120 may set the sensing mode (e.g., one-touch mode or two-touch mode) of the touch panel 113 such that the touch panel 113 senses touch inputs corresponding to the maximum number of touches. For example, the touch panel operation module 120 may sense only a partial area, which includes locations where touch inputs corresponding to the maximum number of touches are sensed, based on the set sensing mode and may not sense the remaining area. Likewise, the operation of the touch sensor corresponding to the maximum number of touches may be achieved by differently setting the driving mode of the sensor based on the number of touches. For example, in the case where the maximum number of touches is ten, the entire corresponding area of the touch panel 113 in the display panel 111 may be always driven and sensed. Meanwhile, in the case where the maximum number of touches is one or two, the local sensing method for extracting coordinates in a tracking manner based on the location of the contact may be used instead of driving and sensing the entire area of the touch panel 113.

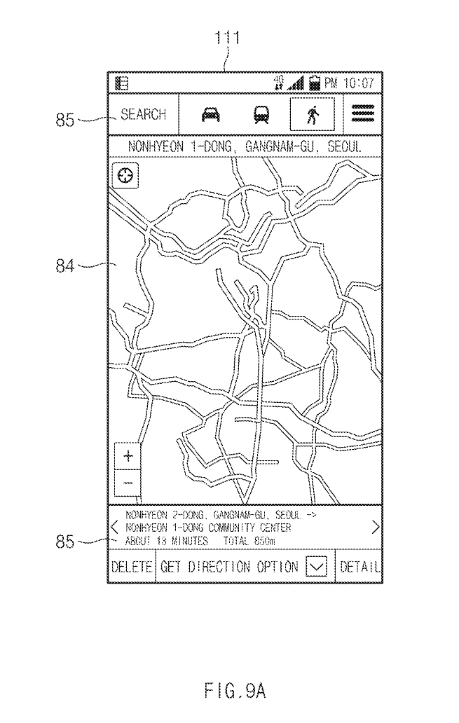

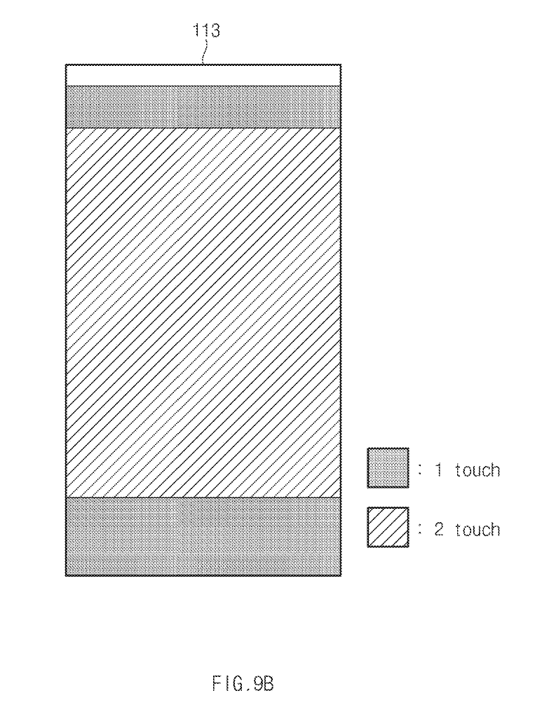

FIGS. 9A and 9B are diagrams illustrating setting of the maximum number of touches according to various embodiments of the present disclosure.

FIG. 9A shows a map application UI displayed on the display panel 111. The processor (e.g., the processor 140) may determine the number of touches about the UI displayed on the display panel 111. For example, the processor (e.g., the processor 140) may determine the number of touches required for specific UIs (or specific areas) displayed on the display panel 111.

Referring to FIG. 9A, the map application UI may include a map 84 and menu and function icons 85. With regard to the area where the map 84 among the UIs displayed on the display panel 111 is displayed, the processor (e.g., the processor 140) may determine that one touch manipulation is required to move the map and may determine that two touch manipulations are required to enlarge or shrink the map. Furthermore, the processor 140 may determine that one touch manipulation is required, with regard to the menu and function icons 85. The number of touches may be set during the design of the corresponding application program, may be changed by a user, or may be included in metadata of the application program. The processor 140 may determine the number of touch manipulations by obtaining information about the number of touch manipulations set for the UI displayed according to execution of the application program on the display panel 111.

Referring to FIG. 9B, the touch panel operation module (e.g., the touch panel operation module 120) may set, for example, the maximum number of touches for an area corresponding to the map 84 to two (two-touch mode) and may set the maximum number of touches for an area corresponding to the menu and function icons 85 to one (one-touch mode). With regard to this operation, the touch panel operation module (e.g., the touch panel operation module 120) may independently operate driving signals applied to each of the touch areas. For example, the touch panel operation module (e.g., the touch panel operation module 120) may operate a first touch area corresponding to the function icon 85 area based on the first driving signal and may operate a second touch area of the touch panel 113 corresponding to the map 84 based on the second driving signal. For example, the touch panel operation module 120 may provide the first driving signal, which is uniquely generated through a frequency division and a code assignment, to the first touch area and may provide the second driving signal, which is distinguished from the first driving signal and is orthogonal to the first driving signal, to the second touch area, thereby making it possible to provide driving signals, which are distinguished from each other, to a plurality of areas. According to various embodiments of the present disclosure, to improve the sensing speed, the touch panel operation module 120 may provide a plurality of driving signals (e.g., a first driving signal and a second driving signal), which have an orthogonal characteristic, to the first touch area and may provide a plurality of driving signals (e.g., a third driving signal and a fourth driving signal), which have an orthogonal characteristic, to the second touch area. According to an embodiment of the present disclosure, if a touch input corresponding to the maximum number of touches set to the specific area of the touch panel 113 is sensed, the touch panel operation module 120 may set a partial area, which includes the sensed location of the touch input, as the sensing area.

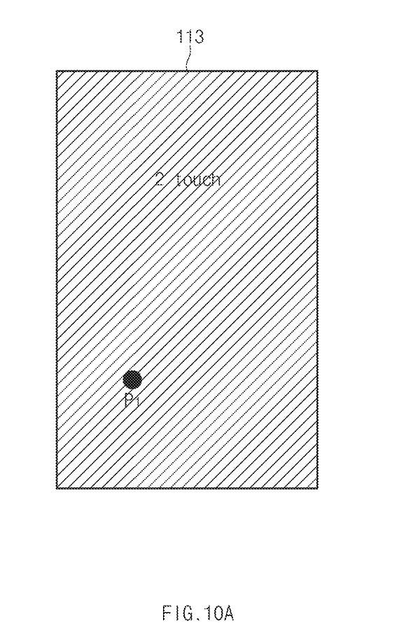

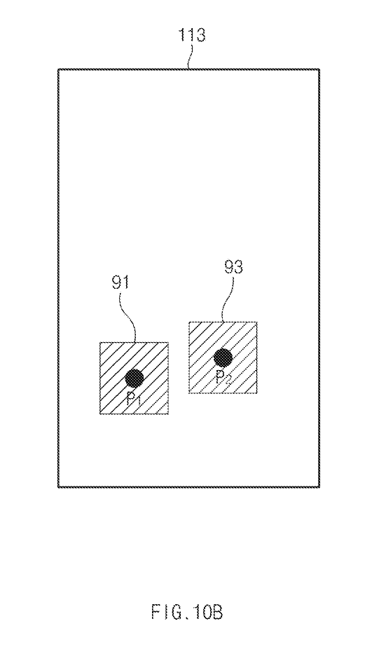

FIGS. 10A and 10B are diagrams illustrating setting of a sensing area based on an input of a touch manipulation according to various embodiments of the present disclosure. Especially, in FIGS. 10A and 10B, an embodiment of the inventive concept is exemplified as a partial area including a sensed position of a touch input is set as the sensing area in the case where the touch input corresponding to the maximum number of touches is sensed.

The touch panel operation module 120 may set a sensing area differently according to the case where the number of touch inputs sensed is less than the maximum number of touches and the case where the number of touch inputs sensed is equal to the maximum number of touches.

Referring to FIG. 10A, for example, the touch panel operation module 120 may set the maximum number of touches about the entire area of the touch panel 113 to two, based on a setting of a running application program. One touch input may be sensed on a specific location P1 of the touch panel 113 with the entire area of the touch panel 113 set as the sensing area. Even though a touch input is sensed, the touch panel operation module 120 may set the entire area as the sensing area because the number of inputted touches is less than the maximum number of touches.

Referring to FIG. 10B, touch inputs corresponding to the maximum number of touches may be sensed in the case where an additional touch input is sensed on P2 with the touch input sensed on P1. In the case where the touch inputs corresponding to the maximum number of touches are sensed, the touch panel operation module 120 may set both the partial area 91 which includes P1 and the partial area 93 which includes P2, as the sensing area.

According to various embodiments of the present disclosure, the touch panel operation module (e.g., the touch panel operation module 120) may operate driving signals differently according to the case where touch inputs of which the number is less than the maximum number of touches are sensed and the case where touch inputs of which the number is equal to the maximum number of touches are sensed. For example, in the case where touch inputs of which the number is less than the maximum number of touches are sensed as shown in FIG. 10A, the P1 touch input may be sensed by providing first driving signals to the entire area of the touch panel 113. In the case where touch inputs of which the number is equal to the maximum number of touches are sensed as shown in FIG. 10B, the touch panel operation module (e.g., the touch panel operation module 120) may provide different driving signals with regard to detection of a P1 area 91 and a P2 area 93.

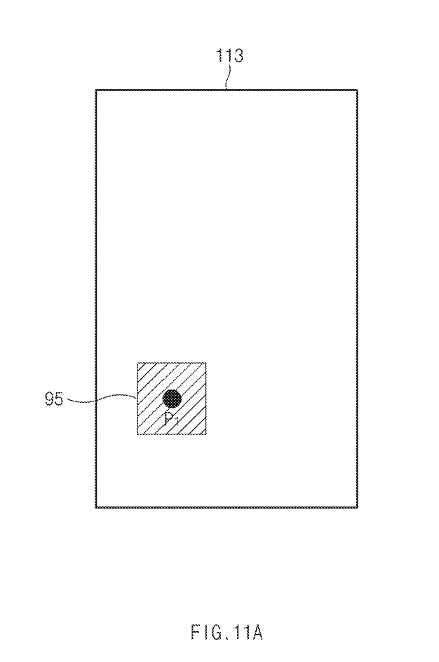

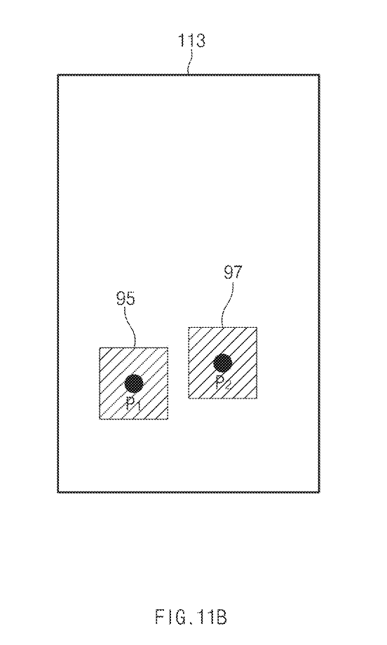

FIGS. 11A and 11B are diagrams illustrating setting of a sensing area based on an input of a touch manipulation according to various embodiments of the present disclosure. In FIGS. 11A and 11B, an embodiment of the present disclosure is exemplified as a partial area which includes a sensed location of a touch input is set as a sensing area if the touch input is sensed regardless of the maximum number of touches.

Referring to FIG. 11A, for example, if a touch input is sensed on P1, the touch panel operation module 120 may set a partial area 95 which includes P1 where a touch input is sensed, as the sensing area.

According to an embodiment of the present disclosure, the touch panel operation module (e.g., the touch panel operation module 120) may sense a partial area including a location, at which a touch manipulation is inputted, and an entire area alternately. For example, the sensing period for sensing the entire area may be inserted every specific time interval in the state where the partial area 95 of the touch panel is set as the sensing area as the user touch input is sensed as shown in FIG. 11A. Accordingly, even in the state where the sensing area is limited due to the sensed touch input, a touch input inputted at another location may be sensed during the sensing period in which the entire area is sensed. In the above-mentioned operation, the touch panel operation module 120 may operate the P1 area 95 using the first driving signal and may periodically sense the entire area using the second driving signal which is distinguished from the first driving signal. Accordingly, the touch panel operation module 120 may determine whether the touch occurs in the P1 area 95 or in the entire area, based on a kind of sensed signal.

Referring to FIG. 11B, in the case where the user inputs an additional touch manipulation on P2 with the touch input sensed on P1, the touch panel operation module 120 may sense the touch manipulation inputted on P2 during the sensing period about the entire area. If the touch input is sensed on P2, the touch panel operation module 120 may set both the partial area 95 which includes P1 and the partial area 97 which includes P2 as sensing areas. According to an embodiment of the present disclosure, the touch panel operation module 120 may provide different driving signals to the P1 area 95 and the P2 area 97. For example, the touch panel operation module 120 may provide the first driving signal to the P1 area 95 and the second driving signal, which is distinguished from the first driving signal, to the P2 area 97. According to an embodiment of the present disclosure, the touch panel operation module 120 may set the entire area as the sensing area in the case where the number of touch inputs received at the same time is three or more.

According to an embodiment of the present disclosure, when the partial area which includes a location where a touch input is sensed is set as the sensing area, the touch panel operation module 120 may set the sensing area in various shapes, such as a square, a rectangle, a circle, and the like. Furthermore, the touch panel operation module 120 may set the sensing area according to the touch input so as to have various sizes based on the number of touch inputs. For example, the touch panel operation module 120 may set the size of the sensing area to be smaller as the number of sensed touch inputs increases.

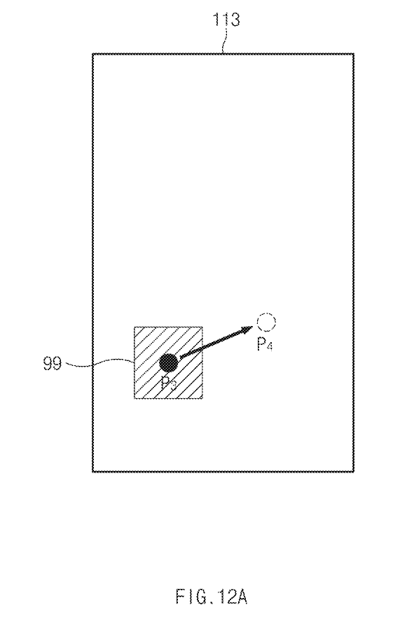

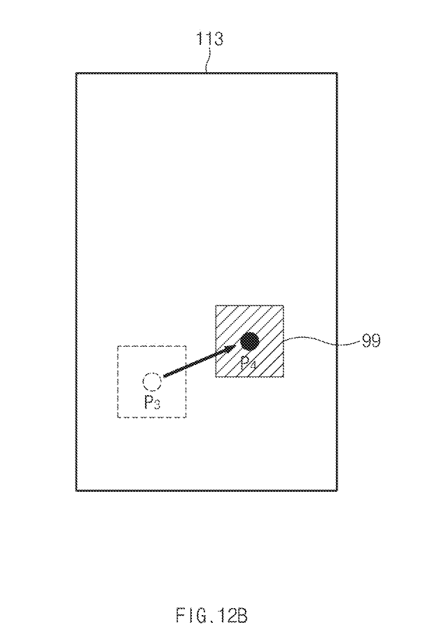

According to an embodiment of the present disclosure, if a location of a touch manipulation inputted to the touch panel 113 moves, the touch panel operation module 120 may change a location of the sensing area so as to correspond to the movement of the touch manipulation. For example, in the case where a partial area of the touch panel is set according to the touch input corresponding to the maximum number of touches as the sensing area or in the case where a partial area of the touch panel is set according to the touch input as the sensing area regardless of the maximum number of touches, the touch panel operation module 120 may change the sensing area such that the set sensing area tracks the touch input as the touch location moves. This will be described with reference to FIGS. 12A and 12B.

FIGS. 12A and 12B are diagrams illustrating a change of a sensing area according to a location of a touch manipulation according to various embodiments of the present disclosure.

Referring to FIG. 12A, if a touch input is sensed at a specific location P3 on the touch panel 113, a partial area 99 which includes the location P3 where the touch input is sensed may be set as the sensing area.

Referring to FIG. 12B, if the location of the touch manipulation moves to P4, the sensing area 99 may move to a direction where the touch manipulation moves. Accordingly, even though a location of a first inputted touch manipulation, such as a swipe, a flick, or the like, moves, sensing may be continuously made by tracking the location of the touch manipulation moving. In the above-mentioned operation, the touch panel operation module 120 according to the present disclosure may sense a partial area (or the entire area) using a plurality of driving signals based on the sensed location P3 of the touch input, thereby precisely tacking the touch movement even though a fast touch operation, such as the flick or the like, occurs.

According to an embodiment of the present disclosure, if receiving information about the sensing area of the pen recognition panel 115 from the processor 140, the touch panel operation module 120 may sense a remaining area other than the sensing area of the pen recognition panel 115. In this operation, the touch panel operation module 120 may have a robust characteristic against the noise due to the driving of the pen recognition panel 115, by using driving signals which has the robust characteristic against the ambient noise signal as the driving signals are generated using the above-described orthogonal frequency division and code assignment method. Accordingly, touch sensing may be processed with high accuracy even though driving signals which use a relatively small amount of power in supplying the driving signals to a touch panel are provided to the touch panel 113 to monitor the user touch. Furthermore, as a partial area of the touch panel 113 is set as the sensing area based on a touch location of a pen as illustrated in FIGS. 12A and 12B, compared with the case that the entire area is sensed, sensing may be possible in fast speed or a sensing rate about the partial area may be increased during the same time. Accordingly, it may be possible to achieve the sensing which is robust to noise and is very sensitive.

According to an embodiment of the present disclosure, in the case where the cover closing is detected with the electronic device 100 coupled with a cover which has a transparent area on the front thereof, an area corresponding to a partial area of the cover (e.g., a transparent area or an opaque area) may be sensed through the touch panel 113. The sensor module 130 may include a sensor (e.g., the illuminance sensor, the infrared sensor, the proximity sensor, the magnetic sensor, or the like) which is able to detect the cover closing. In the case where the cover closing is detected by the sensor, such as the illuminance sensor, the infrared sensor, the proximity sensor, the magnetic sensor, or the like, the sensor hub or the processor 140 may provide information about the open-and-close state of the cover to the touch panel operation module 120. The touch panel operation module 120 may set the sensing area of the touch panel 113 based on the information about the open-and-close state of the cover provided from the sensor hub or the processor 140. For example, the touch panel operation module 120 may set an area corresponding to the transparent area of the cover as the sensing area. According to an embodiment of the present disclosure, the information about the transparent area of the cover may be stored in advance in the memory (not shown). In the above-mentioned operation, the touch panel operation module 120 may provide the first driving signal to the touch panel with the cover closed and may provide the second driving signal to the touch panel with the cover opened. By differentiating the driving signal provided to the transparent area of the cover from the driving signal provided to the opaque area of the cover, the touch panel operation module 120 may process the received signal more clearly and may fundamentally remove a location error of the touch.

According to an embodiment of the present disclosure, the touch panel operation module 120 may control the operation of the touch panel 113 in the specific sensing mode (e.g., the event detection mode) if the specific movement is detected in the electronic device 100 with the sensing of the touch panel 113 being discontinued (e.g., with the display being off). The event detection mode may mean a mode in which whether the touch manipulation is inputted to the touch panel 113 without determining coordinates of the touch input inputted on the touch panel 113.

The motion detection sensor (e.g., the acceleration sensor or the gyro sensor) included in the sensor module 130 may detect the movement of the electronic device 100. The sensor hub or the processor 140 may provide the movement information about the electronic device 100 to the touch panel operation module 120 if the movement information about the electronic device 100 is obtained by the motion detection sensor. The touch panel operation module 120 may operate in the specific sensing mode based on the movement information about the electronic device 100 provided from the sensor hub or the processor 140. For example, the touch panel operation module 120 may operate in the event detection mode if the electronic device 100 receives the motion detection information in the state where there is no movement for the specific time (e.g., one minute). For another example, the touch panel operation module 120 may operate in the event detection mode if there is movement information corresponding to the event that a user lifts the electronic device 100 from a table or pulls out the electronic device 100 from a pocket.

According to an embodiment of the present disclosure, the touch panel operation module 120 may operate in the specific sensing mode (e.g., the event detection mode) if the specific voice is recognized through the microphone with the sensing of the touch panel 113 being discontinued (e.g., with the display being off). The microphone included in the sensor module 130 may detect the user voice. The sensor hub or the processor 140 may provide the voice information about user who uses the electronic device 100 to the touch panel operation module 120 after obtaining the user voice information with the microphone. The touch panel operation module 120 may control the operation of the touch panel 113 in the specific sensing mode based on the user voice information provided from the sensor hub or the processor 140. For example, in the case where information indicating that a voice of a specific user is recognized or information indicating that a specific word is recognized is received with the sensing of the touch panel 113 being discontinued, the touch panel operation module 120 may control the operation of the touch panel 113 in the event detection mode. Furthermore, the touch panel operation module 120 may control to operate in a corresponding sensing mode based on an explicit direction or designation about the corresponding sensing mode for sensing a voice of a specific user with the touch panel 113 not operating or operating. For example, the touch panel operation module 120 may operate in one of the above-mentioned sensing modes, a finger print recognition mode, an event recognition mode, or the like, based on the user voice.

According to an embodiment of the present disclosure, the touch panel operation module 120 may operate in the living body sensing mode based on the application execution information provided from the processor 140. In the case where a fingerprint recognition or the measurement of a heart rate, an electrocardiography, a pulse, or the like is required according to the application use scenario, the touch panel operation module 120 may measure the fingerprint, the heart rate, the electrocardiography, or the pulse through the touch panel 113 by improving the sensing sensitivity of the specific area of the touch panel 113.

According to the above-mentioned various embodiments of the present disclosure, with regard to the improvement of the driving speed and sensitivity of the touch panel 113, the electronic device 100 may apply a direct sequence spread spectrum (DSSS) method to driving signals of the touch panel operation module 120 which operates the touch panel 113 and may apply a method for integrating a charge to the receiving module. Since supporting simultaneous driving based on the multi-channel transmission and receiving, the electronic device 100 may easily support the operation fit to a scan speed even though the size of the touch panel 113 or the number of channels increases. Furthermore, in the electronic device 100, in the case where the report rate of the sensing signal is fixed, the scan speed may be improved or the number of nodes (e.g., electrode lines) capable of being simultaneously processed may increase, thereby reducing a time taken for the receiving module to acquire data and allowing a lot of time to be assigned to signal processing for improvement of the quality of signal. This may mean that the electronic device 100 improves the signal-to-noise ratio and the sensitivity and accuracy of the touch panel.

Furthermore, the electronic device 100 may variably set the sensing mode and the sensing area of the touch panel 113 based on whether a user utilizes the electronic device 100, thereby reducing power consumption of the touch panel and improving the sensing speed of the touch panel. Furthermore, the sensitivity and accuracy may be improved by increasing the signal throughput for improvement of the quality of signal, such as sensing signal, integration, filtering, and the like, as the sensing speed is improved.

According to various embodiments of the present disclosure, an electronic device may include a touch panel including a plurality of transmission electrode lines and a plurality of receiving electrode lines and a touch panel operation module configured to select a part of the plurality of transmission electrode lines and the plurality of receiving electrode lines and to sense a partial area of the touch panel based on a sensing mode.

According to an embodiment of the present disclosure, the touch panel operation module may include a transmission module for providing a driving signal to the touch panel, a receiving module for receiving a received signal from the touch panel, a transmission channel selection switch for selecting a transmission electrode line through which a driving signal is provided, a receiving electrode line selection switch for selecting a receiving electrode line through which a received signal is received, and a control module for selecting a part of the plurality of transmission electrode lines and the plurality of receiving electrode lines and to sense a partial area of the touch panel.

According to an embodiment of the present disclosure, the touch panel operation module may simultaneously sense a partial area of the touch panel using a plurality of driving signals with unique code information.

According to an embodiment of the present disclosure, the touch panel operation module may generate a plurality of driving signals with unique code information and may provide the plurality of driving signals to different areas, respectively.

According to an embodiment of the present disclosure, the electronic device may further include a display panel configured to display a UI and the touch panel operation module may sense a partial area corresponding to an effective touch area if information about the effective touch area of a UI displayed on the touch panel is received.

According to an embodiment of the present disclosure, the touch panel operation module may set a sensing rate or a signal throughput of the partial area high.

According to an embodiment of the present disclosure, if a touch input is sensed on the touch panel, the touch panel operation module may sense a partial area including a location at which the touch input is sensed.

According to an embodiment of the present disclosure, if a location of the touch input moves, the touch panel operation module may change a sensing area so as to correspond to a movement of the touch input.

According to an embodiment of the present disclosure, the touch panel operation module may sense a partial area including the location at which the touch input is sensed and an entire area of the touch panel alternately in a specific rate.

According to an embodiment of the present disclosure, the electronic device may further include a pen recognition panel configured to sense an EMR pen manipulation and the touch panel operation module may sense a remaining area other than a sensing area of the pen recognition panel if information about the sensing area of the pen recognition panel is received.

According to an embodiment of the present disclosure, the touch panel operation module may sense an area of the touch panel corresponding to a transparent area of a cover with a transparent area on a front thereof, if information indicating that the cover is closed is received with the electronic device coupled with the cover.

According to an embodiment of the present disclosure, the electronic device may further include a display panel configured to display a UI and the touch panel operation module may sense a touch input corresponding to a maximum number of touches if information about the maximum number of touches corresponding to the UI displayed on the display panel is received.

According to an embodiment of the present disclosure, the electronic device may further include a motion detection sensor configured to detect a movement of the electronic device and the touch panel operation module may operate in an event detection mode if a specific movement is detected on the electronic device with a sensing of the touch panel being discontinued.

According to an embodiment of the present disclosure, the electronic device may further include a microphone for detecting a user voice and the touch panel operation module may operate in a specific sensing mode if a voice is detected through the microphone with a sensing of the touch panel being discontinued.

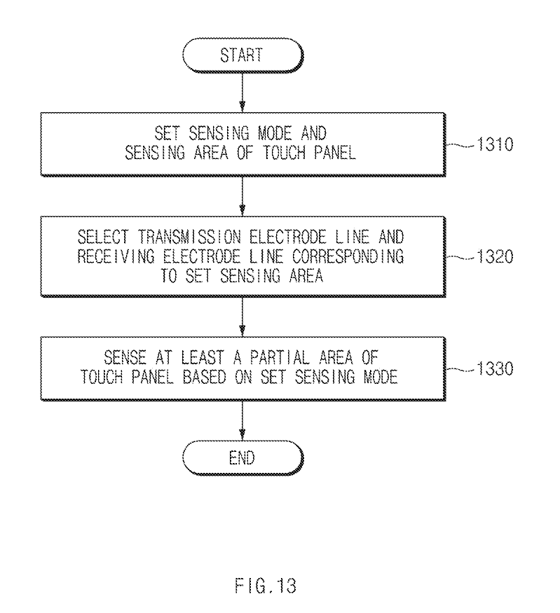

FIG. 13 is a flowchart illustrating a touch sensing method of an electronic device according to various embodiments of the present disclosure. The flowchart illustrated in FIG. 13 may include the operations processed in the electronic device 100 shown in FIG. 1. Even though omitted below, information about the electronic device described with reference to FIGS. 1 to 12 may be applied to the flowchart shown in FIG. 13.

Referring to FIG. 13, the electronic device 100, in operation 1310, may set a sensing mode and a sensing area of the touch panel 113. According to various embodiments of the present disclosure, the electronic device 100 may set the sensing mode and the sensing area of the touch panel 113 based on a UI, an operating state of a running application or the sensor module, or the like.

According to an embodiment of the present disclosure, the electronic device 100 may determine an effective touch area of the UI displayed on the display panel 111 and may set a partial area corresponding to the effective touch area as the sensing area.

According to an embodiment of the present disclosure, if the touch input is sensed on the touch panel 113, the electronic device 100 may set a partial area, including a location where the touch input is sensed, as the sensing area. For example, if touch inputs corresponding to the maximum number of touches set to the specific area are sensed, the electronic device 100 may set a partial area which includes locations where the touch inputs are sensed, as the sensing area. For another example, the electronic device 100 may set, as the sensing area, a partial area which includes a location where the touch input is sensed, regardless of the maximum number of touches.

According to an embodiment of the present disclosure, in the case where a partial area which includes the location where the touch manipulation is inputted is set as the sensing area, the electronic device 100 may set the sensing area so as to sense a partial area which includes the location where the touch manipulation is inputted and the entire area alternately. For example, a sensing period in which the entire area is sensed may be inserted every specific time interval in the state where a partial area of the touch panel is set as the sensing area as the touch input of the user is sensed.

According to an embodiment of the present disclosure, when a partial area which includes a location where the touch input is sensed is set as the sensing area, the electronic device 100 may set the sensing area in various shapes, such as a square, a rectangle, a circle, and the like. Furthermore, the electronic device 100 may set the sensing area according to the touch input so as to have various sizes based on the number of touch inputs. For example, the electronic device 100 may set the size of the sensing area to be smaller as the number of sensed touch inputs increases.

According to an embodiment of the present disclosure, if the location of the touch manipulation inputted to the touch panel 113 moves, the electronic device 100 may change the location of the sensing area so as to correspond to the movement of the touch manipulation. For example, the electronic device 100 may change the sensing area such that the sensing area set to correspond to the touch input tracks the touch input.

According to an embodiment of the present disclosure, if the cover closing is detected with the electronic device 100 coupled with a cover which includes a transparent area on the front thereof, the electronic device 100 may set an area corresponding to the transparent area of the cover as the sensing area.

According to an embodiment of the present disclosure, if a partial area of the touch panel 113 is set as the sensing area, the electronic device 100 may set the sensing rate of the sensing area to be higher than that when the entire area is sensed. For example, the electronic device 100 may perform additional signal processing about the sensing area such as filtering.

According to an embodiment of the present disclosure, the electronic device 100 may determine the maximum number of touches about a UI displayed on the display panel 111 and may set the sensing mode so as to sense only the touch input corresponding to the maximum number of touches. For example, the electronic device 100 may set the maximum number of touches about a partial area of the touch panel to one (one-touch mode) and may set the maximum number of touches about the remaining area to two (two-touch mode).

According to an embodiment of the present disclosure, the electronic device 100 may switch the sensing mode to the event detection mode if a specific movement is detected in the electronic device 100 with the sensing of the touch panel 113 being discontinued (e.g., with the display being off).

According to an embodiment of the present disclosure, the electronic device 100 may set the sensing mode to the event detection mode if a specific voice is recognized through the microphone with the sensing of the touch panel 113 being discontinued (e.g., with the display being off).

According to an embodiment of the present disclosure, the electronic device 100 may set the sensing mode of the touch panel 113 to a living body sensing mode based on the application execution information. For example, in the case where a fingerprint recognition or the measurement of a heart rate, an electrocardiography, a pulse, or the like is required according to the application use scenario, the electronic device 100 may measure the fingerprint, the heart rate, the electrocardiography, or the pulse by improving the sensing sensitivity of the specific area of the touch panel 113.

The electronic device 100, in operation 1320, may select a transmission electrode line(s) and a receiving electrode line(s) corresponding to the set sensing area. For example, the electronic device 100 may select at least a part of a plurality of transmission channels (or electrode lines) of the touch panel 113 using the transmission channel selection switch 127 such that driving signals are supplied to a specific area of the touch panel 113. According to an embodiment of the present disclosure, the electronic device 100 may select at least a part of the plurality of transmission channels, for a group, using the group selection switch 3. For example, the electronic device 100 may select at least a part of a plurality of receiving channels (or electrode lines) of the touch panel 113 such that received signals are provided from the specific area of the touch panel 113. According to an embodiment of the present disclosure, the electronic device 100 may select at least a part of the plurality of receiving channels, for a group, using the group selection switch 7.

The electronic device 100, in operation 1330, may sense at least a partial area of the touch panel 113 based on the set sensing mode. According to an embodiment of the present disclosure, the electronic device 100 may provide driving signals (e.g., transmission signals or transmission channel signals) to the transmission module 123 and may analyze received signals (e.g., sensor signals or receiving channel signals) which the receiving module 125 receives. The electronic device 100 may determine whether the touch manipulation is inputted on the touch panel 113 or whether the touch manipulation is inputted at a specific location or a specific area of the touch panel 113, based on the analysis result of the received signals.

According to an embodiment of the present disclosure, the electronic device 100 may generate driving signals corresponding to the set sensing mode. According to an embodiment of the present disclosure, the electronic device 100 may assign a unique code to the generated driving signal. According to an embodiment of the present disclosure, the electronic device 100 may generate a plurality of driving signals corresponding to a plurality of code information or signal information. The electronic device 100 may provide the driving signals to the touch panel 113. According to an embodiment of the present disclosure, the electronic device 100 may provide a plurality of driving signals into different areas of the touch panel. For example, the transmission module 123 may simultaneously provide the driving signals to specific electrode lines (or channels) of the touch panel 113 selected by the transmission channel selection switch 127. According to an embodiment of the present disclosure, the electronic device 100 may simultaneously provide different driving signals to transmission channels of the touch panel 113.

According to various embodiments of the present disclosure, a touch sensing method of an electronic device may include setting a sensing mode and a sensing area of a touch panel including a plurality of transmission electrode lines and a plurality of receiving electrode lines, selecting a transmission electrode line and a receiving electrode line corresponding to the set sensing area using a channel selection switch, and sensing a partial area of the touch panel based on the set sensing mode.

According to an embodiment of the present disclosure, the sensing of the partial area of the touch panel may include generating a plurality of driving signals with a plurality of code information and providing the plurality of the driving signals to the partial area of the touch panel at the same time.

According to an embodiment of the present disclosure, the sensing of the partial area of the touch panel may include generating a plurality of driving signals with a plurality of code information and providing the plurality of the driving signals to different areas, respectively.

According to an embodiment of the present disclosure, the setting of the sensing area may include displaying a UI on a display panel, determining an effective touch area of the UI displayed on the display panel, and setting an area corresponding to the effective touch area as a sensing area.

According to an embodiment of the present disclosure, the setting of the sensing area may include setting a partial area, including a location where a touch input is sensed, as a sensing area if the touch input is sensed on the touch panel.

According to an embodiment of the present disclosure, the setting of the sensing area may further include changing a sensing area so as to correspond to a movement of the touch input if the location of the touch input moves.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments of the present disclosure may be, for example, implemented by instructions stored in a non-transitory computer-readable storage media in the form of a program module. The instruction, when executed by one or more processors (e.g., a processor 140), may cause the one or more processors to perform a function corresponding to the instruction. The non-transitory computer-readable storage media, for example, may be a memory.

The non-transitory computer-readable recording medium may include a hard disk, a magnetic media, a floppy disk, a magnetic media (e.g., a magnetic tape), an optical media (e.g., a compact disc read only memory (CD-ROM) and a DVD, a magneto-optical media (e.g., a floptical disk), and hardware devices (e.g., a ROM, a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a program module according to various embodiments of the present disclosure may include at least one of the above elements, or a part of the above elements may be omitted, or additional other elements may be further included. Operations performed by a module, a program module, or other elements according to various embodiments of the present disclosure may be executed sequentially, in parallel, repeatedly, or in a heuristic method. Also, a part of operations may be executed in different sequences, omitted, or other operations may be added.

According to various embodiments of the present disclosure, power consumption of the touch sensor may be reduced by sensing only a required area based on the UI displayed on the display and the application use scenario.

Furthermore, the sensing speed may be improved by sensing the specific area at the same time using a plurality of driving signals, and the touch manipulation may be recognized more accurately by improving the sensitivity for the area on which the sensing is required.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a touch panel comprising a plurality of transmission electrode lines and a plurality of receiving electrode lines; and
a touch panel operation module configured to:
select a part of the plurality of transmission electrode lines and the plurality of receiving electrode lines, and
sense a partial area of the touch panel based on a sensing mode.

2. The electronic device of claim 1, wherein the touch panel operation module comprises:
a transmission module configured to provide a driving signal to the touch panel;
a receiving module configured to receive a received signal from the touch panel;
a transmission channel selection switch configured to select a transmission electrode line through which the driving signal is provided;
a receiving electrode line selection switch configured to select a receiving electrode line through which a received signal is received; and
a control module configured to select a part of the plurality of transmission electrode lines and the plurality of receiving electrode lines and to sense a partial area of the touch panel.

3. The electronic device of claim 2, wherein the touch panel operation module is configured to simultaneously sense a partial area of the touch panel using a plurality of driving signals with unique code information.

4. The electronic device of claim 2, wherein the touch panel operation module is configured to generate a plurality of driving signals with unique code information and to provide the plurality of driving signals to different areas, respectively.

5. The electronic device of claim 1, further comprising:
a display panel configured to display a user interface (UI),
wherein the touch panel operation module is configured to sense a partial area corresponding to an effective touch area if information about the effective touch area of a UI displayed on the touch panel is received.

6. The electronic device of claim 5, wherein the touch panel operation module sets a sensing rate or a signal throughput of the partial area high.

7. The electronic device of claim 1, wherein, if a touch input is sensed on the touch panel, the touch panel operation module is configured to sense a partial area comprising a location at which the touch input is sensed.

8. The electronic device of claim 7, wherein, if a location of the touch input moves, the touch panel operation module is configured to change a sensing area so as to correspond to a movement of the touch input.

9. The electronic device of claim 7, wherein the touch panel operation module is configured to sense a partial area comprising the location at which the touch input is sensed and an entire area of the touch panel alternately in a specific rate.

10. The electronic device of claim 1, further comprising:
a pen recognition panel configured to sense an electromagnetic resonance (EMR) pen manipulation,
wherein the touch panel operation module is configured to sense a remaining area other than a sensing area of the pen recognition panel if information about the sensing area of the pen recognition panel is received.

11. The electronic device of claim 1, wherein the touch panel operation module is configured to sense an area of the touch panel corresponding to a transparent area of a cover with a transparent area on a front thereof, if information indicating that the cover is closed is received with the electronic device coupled with the cover.

12. The electronic device of claim 1, further comprising:
a display panel configured to display a user interface (UI),
wherein the touch panel operation module is configured to sense a touch input corresponding to a maximum number of touches if information about the maximum number of touches corresponding to the UI displayed on the display panel is received.

13. The electronic device of claim 1, further comprising:
a motion detection sensor configured to detect a movement of the electronic device,
wherein the touch panel operation module is configured to operate in an event detection mode if a specific movement is detected on the electronic device with a sensing of the touch panel being discontinued.

14. The electronic device of claim 1, further comprising:
a microphone configured to detect a user voice,
wherein the touch panel operation module is configured to operate in a specific sensing mode if a voice is detected through the microphone with a sensing of the touch panel being discontinued.

15. A touch sensing method of an electronic device, the method comprising:
setting a sensing mode and a sensing area of a touch panel comprising a plurality of transmission electrode lines and a plurality of receiving electrode lines;
selecting a transmission electrode line and a receiving electrode line corresponding to the set sensing area using a channel selection switch; and
sensing a partial area of the touch panel based on the set sensing mode.

16. The method of claim 15, wherein the sensing of the partial area of the touch panel comprises:
generating a plurality of driving signals with a plurality of code information; and
providing the plurality of the driving signals to the partial area of the touch panel at the same time.

17. The method of claim 15, wherein the sensing of the partial area of the touch panel comprises:
generating a plurality of driving signals with a plurality of code information; and
providing the plurality of the driving signals to different areas, respectively.

18. The method of claim 15, wherein the setting of the sensing area comprises:
displaying a user interface (UI) on a display panel;
determining an effective touch area of the UI displayed on the display panel; and
setting an area corresponding to the effective touch area as a sensing area.

19. The method of claim 15, wherein the setting of the sensing area comprises:
setting a partial area, comprising a location where a touch input is sensed, as a sensing area if the touch input is sensed on the touch panel.

20. The method of claim 19, wherein the setting of the sensing area further comprises:
changing a sensing area so as to correspond to a movement of the touch input if the location of the touch input moves.
